(19) United States
(12) Patent Application Publication
(10) Pub. No.: US 2011/0261060 A1
(43) Pub. Date: Oct. 27, 2011

(54) DRAWING METHOD AND COMPUTER PROGRAM

(76) Inventors: Markus WAIBEL, Zurich (CH); Louis Paschoud, Rossiniere (CH)

(21) Appl. No.: 13/091,186

(22) Filed: Apr. 21, 2011

(30) Foreign Application Priority Data
Apr. 23, 2010 (CH) CH00599/10

(51) Int. Cl. G06T 13/00

(52) U.S. Cl. 345/473

(57) ABSTRACT

The present invention provides an easy method for creating animations from drawings. A user utilizes a user interface of an electronic media to draw a first line, then to go back in the recording's timeline, and then to draw a second line, such that a playback of the recording shows at least some portion of the first and second lines being drawn simultaneously. This allows a user to easily create animations from drawings for the purpose of visualization, art, entertainment, or encoding of synchronized motion. The invention allows for various ways in which the computer can receive a user's drawing events, in which drawing events are associated with timelines to create a recording, in which drawing events are displayed, and in which the playback of drawing events is saved.

### REFERENCE DATA

The present application claims priority from Swiss patent application CH00599/10 filed Apr. 23, 2010, the contents whereof are hereby incorporated by reference in their entirety.

### PREAMBLE

The headings are for reference purposes only and do not affect in any way the meaning or interpretation. Whenever the words “include”, “including”, “includes”, “e.g.”, “for instance”, “for example”, “among others”, “such as” are used, they are deemed to be followed by the words “without limitation”. The use of “or” is not intended to be exclusive, unless expressively indicated otherwise.

### TECHNICAL DOMAIN

The invention generally relates to the field of electronic arts. More specifically, the present invention relates to a computer or a server with a function for inputting and displaying drawn graphics or images.

### BRIEF SUMMARY OF THE INVENTION

The present invention provides an easy method for creating animations from drawings by allowing to replay and edit consecutively drawn lines in a non-consecutive way for the purpose of art, or visualization or encoding of synchronized motion. This is achieved by providing a user with a method and means to directly manipulate a drawings timelines.

### BACKGROUND OF THE INVENTION

### Related Art

The present invention relates to two fields: Digital drawing and digital animation.

### Digital Drawing

Digital drawing has become increasingly popular due to advances in hardware (e.g., touch-screen devices, drawing pads, high-resolution screens) and in software (e.g., browser-based applications, online portals). This has resulted in the formation of large online communities (e.g., deviantart.com, sketchfu.com, odopod.com) dedicated to the creation and sharing of digital drawings, with thousands of drawings per day. Current state-of-the art drawing tools such as Adobe Photoshop or those offered by the aforementioned websites feature many advanced tools (e.g., brushes, layers, filters) for the creation and manipulation of graphics. However, their focus is the creation of static images. The possibilities for creating moving graphics are restricted to applying functions to existing graphics (e.g., equation-based movement, morphing, interpolation), combining multiple individual graphics into an animation (e.g., animated GIFs), or playback of a recording of the graphic's creation.

WO2008112847 discloses a creative tool and system that may be utilized for entertainment purposes by a user. The creative tool utilizes an electronic media to allow a user to draw one or more lines with a user interface on which a moving object such as a sled may ride after the completion of the drawing by the user. The creative tool and system employs a computer program that may allow the user to input a set of parameters using a free hand drawing tool that is then graphically displayed to the user after they have input the parameters. Additionally, the input parameters are subject to natural velocity and trajectory forces from the moving object along the graphical representation displayed to the user. Additionally, the moving object is central on the graphical display and will continue until the parameters are interrupted or velocity and trajectory provide deviation from the user's parameters.

U.S. Pat. No. 6,373,490 discloses a graphical rendering system and method which stores generated and calculated path parameters along the entire user drawn path. These stored parameters are then editable or otherwise filtered at any point so as to create for the user different effects without the necessity of redrawing any portion of the path. Color changes or blends can be created along the length of the path or at any specific segment such as overdraws where the color is darker due to the overdraw. The system and method allow for changing of pen type and for giving different weights to certain of the stored parameters depending upon the currently selected pen type, color choice, light source shading, or desired rendered media.

U.S. Pat. No. 7,116,844 discloses an invention relating to obtaining vector data for a hand-drawn curve having coordinate values input from a pointing device and a thickness and/or density in accordance with pen pressure values. In order to reduce the amount of data input from the pointing device and obtain vector data therefor in real time, the coordinate data and pen pressure data are extracted independently of each other so as to reduce the amount of data stored in a memory and used for plotting or display.

### Digital Animation

Digital animation, as described in “Encyclopedia of Animation Techniques” by Richard Taylor (2004) and “Computer animation: algorithms and techniques” by Rick Parent (2001), is historically based on frames, i.e. images with identical size displayed in a specific order and timing. Current state-of-the-art animation uses two main methods: Keyframe animation and motion capture. Keyframe animation relies on the definition of specific frames of special importance, with intermediate frames created in a separate step called “inbetweening” or “tweening” to give the appearance that a first keyframe evolves smoothly into a following keyframe. Traditionally inbetweening was performed using light tables, modern methods use computers to allow for easier drawing (using e.g., onion skinning) or automatic creation (using e.g., morphing software) of tweens. Motion capture uses a camera to record frames of the motion of people (e.g., a dancer) or objects (e.g., a paper airplane). The resulting frames are then post-processed using specialized software. Alternative techniques are based on applying functions to graphics as mentioned above. While current state-of-the-art tools such as Autodesk Max3D Studio, Canvas X, Adobe After Effects feature many ways of moving and animating graphics, they focus on the use of keyframes, which requires a complex, technical process not well suited for many users and not well suited for many applications such as those described below.

US20070109304 discloses a method and system producing animations based on drawings. It proposes services to casual users, having little or no experience in creating animations or using animation software packages. One or more individuals create one or more drawings that will serve as the basis for the animation and a storyline for the characters and other elements in the drawings. The drawings and storyline are sent to an animation services system, along with optional audio selections. At the animation services system, the drawings are opened using image processing software, parsed into a number of logical subunits, and animated using image animation software. Sound effects, music and other audible components are then added to the animation. The completed animation is then provided to the individuals and optionally posted on a website accessible through the Internet. In another aspect, the invention includes a software system for receiving requests for animation services from clients, assigning those requests to animators, and providing the completed animations to the clients.

US20040174365 discloses methods and systems that in accordance with the present invention provide computer animation in which drawing lines or marks are erased after a predetermined time interval. When the lines or marks are automatically erased after a set interval, animations may be created with relatively little effort. Methods and systems in accordance with the present invention provide an easy, intuitive way to create animations by recording drawing events in sequence and playing back these events at a defined rate while erasing old events after a predetermined interval. The persistence interval, which can be defined, for example, in time or by a function of the relative order the line was drawn (“line drawn index”), and the playback rate may be defined by the creator of the animation for each drawing event. The result of this process is a dynamically changing drawing which can be replayed as an animation.

US20030016787 discloses a method and apparatus for producing an overall image from a number of partial images which are produced successively for common playback, a first partial image is produced and stored, and at least a portion of the first partial image, that adjoins a second partial image to be produced, is played back. A survey image is produced for the second partial image and this survey image is simultaneously played back with the first partial image, with overlapping regions adjoining each other. From this simultaneous playback, the correct orientation of the exposure region for the second partial image is selected, and the image acquisition device is correspondingly positioned and the second partial image is produced. The first and second partial images are then joined to form the overall image.

A common problem with many related art solutions is the complexity of their usage and implementation, which makes them unsuitable for non-expert users, hinders their implementation on many hardware platforms (e.g., mobile devices) and hinders their implementation on many software platforms (e.g., browsers).

Another common problem with many related art solutions is that they are based on frames, or require the definition of keyframes, or require the definition of animation variables (“Avars”). All of these require an additional, intermediate, ad-hoc step of separating the timeline into intervals, resulting in additional workload, increased complexity of usage and implementation, and reduced applicability.

Another common problem with many related art solutions is that they require user input to help define a function (e.g., morphing, scanimate, interpolation, transformation, orientation, or kinematic modeling) to alter or animate a drawing, requiring an additional step and increasing complexity.

Another common problem with many related art solutions is that they require input to be presented in a serial format.

Another common problem with many related art solutions is that they are limited to the animation of objects. This hinders or prevents their applicability to drawing, writing or painting.

One aim of the present invention is thus to provide a user-friendly and easy-to-implement way of producing animations based on drawing simple shapes such as lines in combination with a way to access the drawing's timelines.

Another aim of the present invention is to allow the production of animations without the use of frames in general, and in particular without the constraints and effort imposed by the use of keyframes.

Another aim of the present invention is to allow animation without user definition of a function.

Another aim of the present invention is to provide an easy method for input to be presented in parallel.

Another aim for the present invention is to provide an easy method applicable to objects, shapes, drawings, writing and paintings.

Another aim of the present invention is to allow users to produce animations based on drawing simple shapes such as lines in combination with a way to access another operation, linked to or separate from, the drawing's timeline, such as a zoom, rotation or shift operation.

### BRIEF DESCRIPTION

The present invention utilizes a user interface of an electronic media to allow a user to input and record information by drawing a first line, then to go back in the timeline of the recorded input, and then to input additional information by drawing a second line, such that a playback of the two timelines shows at least some portion of both lines being drawn simultaneously. This provides an easy method for a user to create animations from drawings for the purpose of visualization, art, entertainment, or encoding of synchronized motion.

It is another object of the present invention to provide means to link timelines to processing rules for inputting, recording, altering and playing back of an animation.

It is another object of the present invention to provide means for control of the timelines. In particular it allows to use the starting or end points in the timelines of drawing events to switch between modes of advancing through the timelines, or to jump to defined positions in the timelines.

In order to achieve the above, the present invention allows for various ways of inputting, recording, altering and playing back the relation of drawing events with their associated timelines. In particular, the present invention allows for recording, alteration and playback while advancing through the timelines at different speeds, forwards and backwards, as well as pausing the progression in the timelines.

In order to achieve the above, the present invention also allows for various types of drawing events including objects, letters, symbols and lines of unitary length (points).

The present invention may be used as an enhancement and in combination with tools known from the prior art for the inputting, recording, altering and playing back of drawings and animations. In particular, it allows for various ways of controlling the timelines and of easy input, recording, altering and playback of sub-sections of drawing events in space or time. In particular, the present invention allows to use the timelines of drawing events to link drawing events created at different times, by different users in different locations in both time (e.g., one after the other, partially overlapping, etc.) and space (e.g., one next to the other, partially overlapping, etc.).

### DESCRIPTION OF THE FIGURES

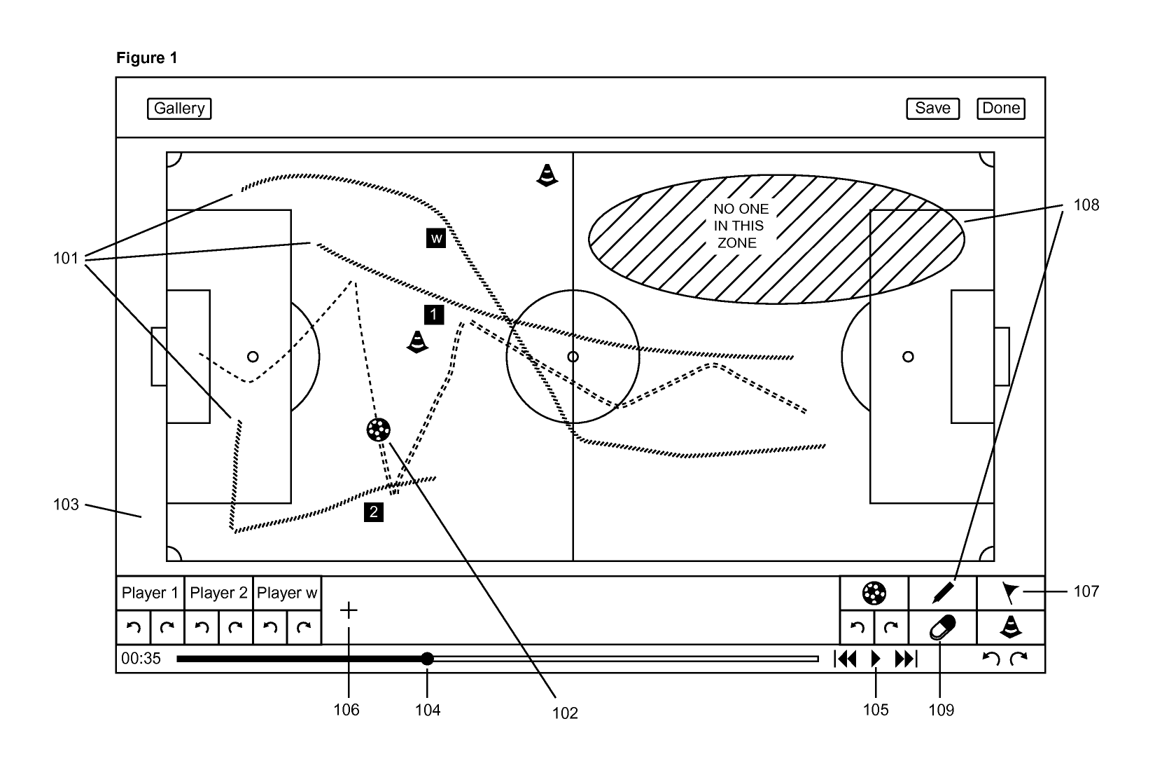

FIG. 1 shows a screenshot of a sample embodiment of the application with important elements for user interaction.

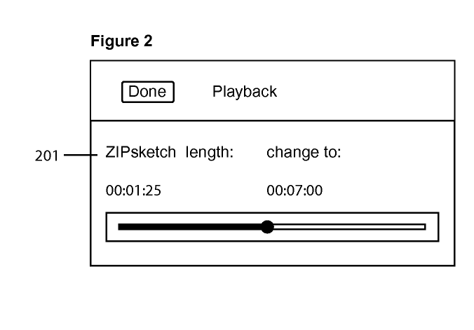

FIG. 2 shows a screenshot of a sample embodiment of an element for user interaction that allows to change the drawing's playback speed.

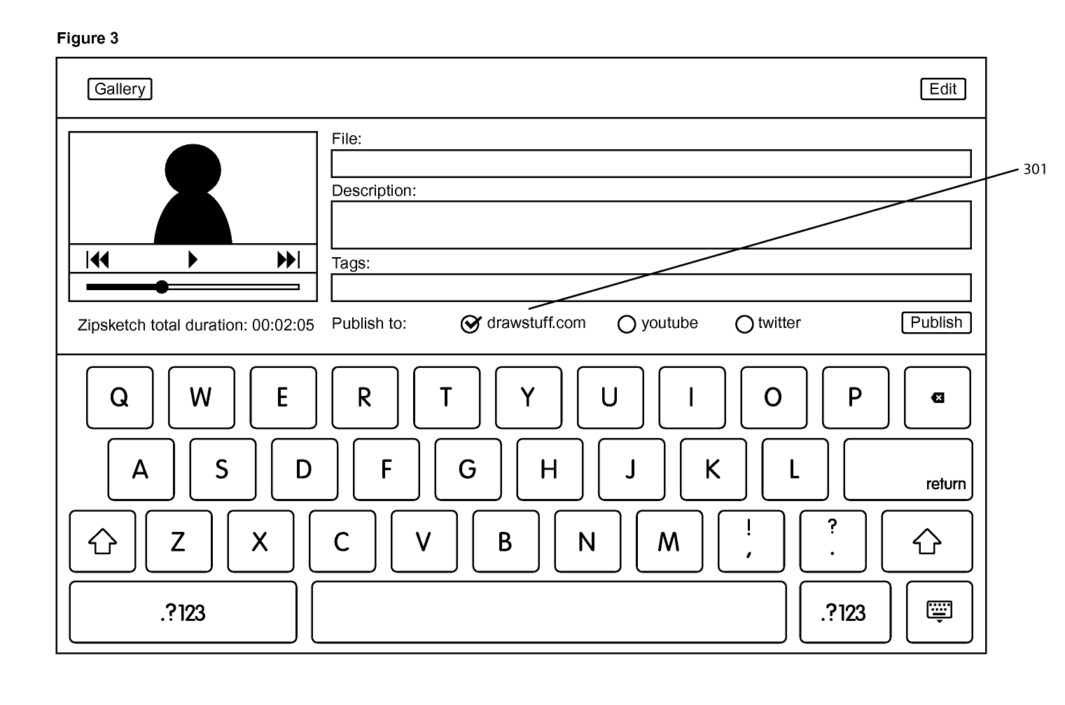

FIG. 3 shows a screenshot of a sample embodiment of an element that allows a user to share their animation with other users via popular online networks.

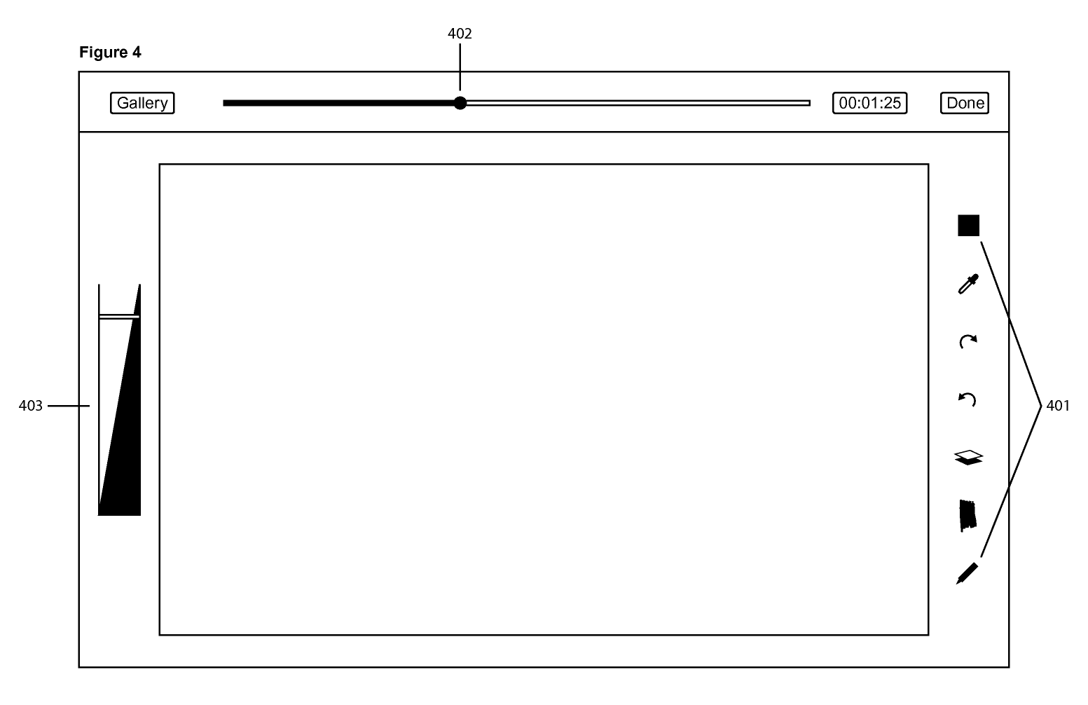

FIG. 4 shows a screenshot of another, different sample embodiment of the drawing application with important elements for user interaction.

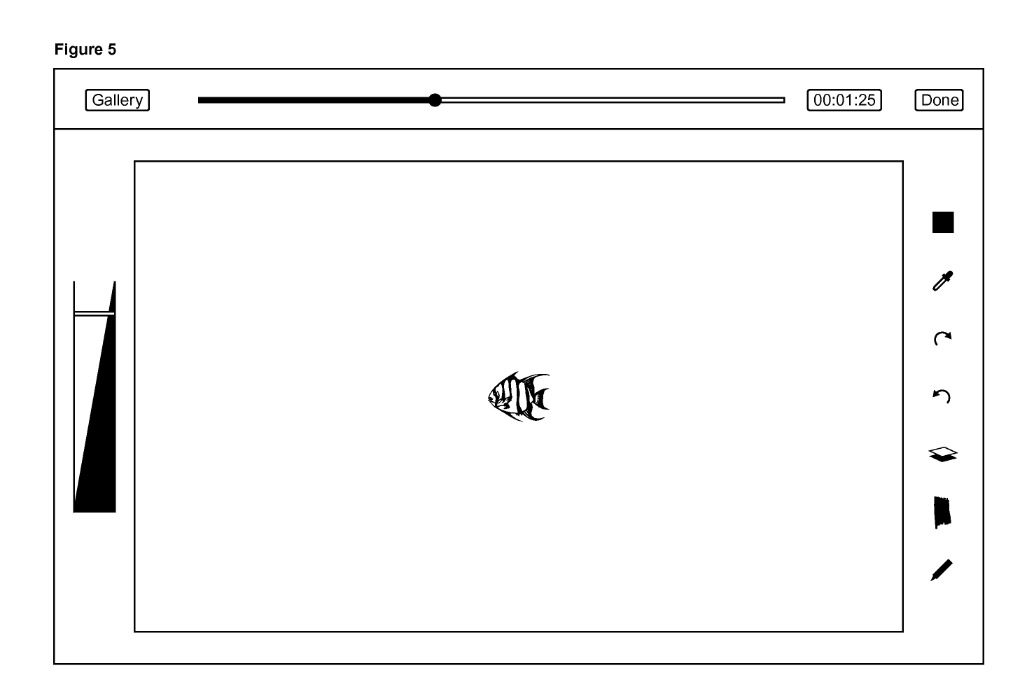

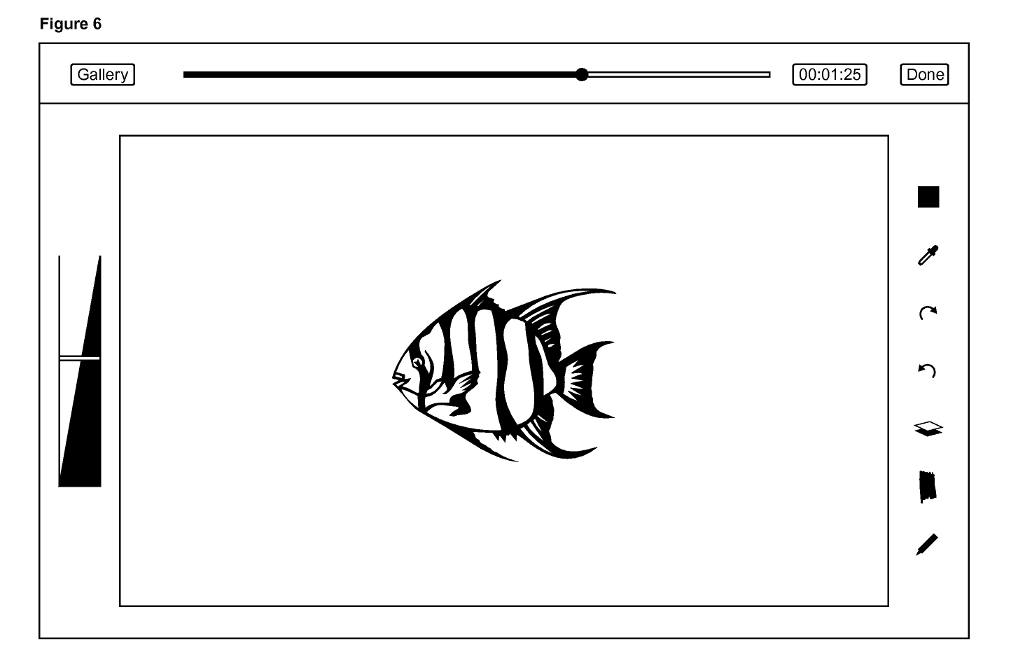

FIGS. 5 and 6 show two screenshots of another, different sample embodiment of the drawing application, in which the scrollbar is used to control a zoom function instead of the drawings timeline.

### DETAILED DESCRIPTION

In a first, preferred embodiment intended for an application and described with reference to FIG. 1, the present invention allows a sports team coach to quickly and easily sketch the movement of players 101 and a ball 102 on her mobile touch screen device. The mobile touch screen device includes a programmable processor and has access to a memory area containing a software program to execute the inventive method when they are executed by the processor. Furthermore, the mobile touch screen device includes a touch screen, or other input means, arranged to receive indications of drawing events or other commands, via a suitable user interface. The invention is suitable for mobile or portable devices, like tablets, smartphones, videogame consoles and so on, and is described herewith with reference to portable devices for simplicity, but it not limited to those devices and applies as well to personal computers or any suitable programmable device. It must be understood also that the inventive steps need not be executed on a single device, but that the invention can be implemented in a distributed environment, for example as a web service, that is executed in one or several servers, receiving indications of drawing events or other instructions from remote users via the internet.

The inventive method proceeds by the coach drawing a first line to illustrate the movement of player 1 on a canvas representing the playing field 103; the mobile touch screen device receives indications of this first event, and this event is associated with a first timeline. The coach then uses a scrollbar 104 to return to the beginning of the animation, and draws a second line to illustrate the movement of player 2; the mobile touch screen devices receives indications of this second drawing event, which is then associated with a second timeline. Then again using the scrollbar 104 to return to an earlier moment in the animation, the coach draws a third line illustrating the movement of the ball 102 between players 101, which is associated with a further timeline. The three timelines are associated with one another in a relation of synchronicity, according to the movements of the scrollbar 104. The coach can then play back 105 the complete animation to show the three timelines of the players 101 and the ball 102 simultaneously according to the association of the timelines. In this first, preferred embodiment recording of subsequent timelines happens during replay of previous timelines. In addition to lines, the coach can also easily add and remove other moving objects (e.g., players of the opposing team) 106 or static objects (e.g., the goal) 107 or static drawings 108 to the animation.

This preferred embodiment also has provisions to easily alter an animation using simple actions such as drag-and-drop, copy-paste, scaling, or distortion operations. For example, the coach can edit lines by using the scrollbar 104 to move to a specific point in time, then clicking on the end point of a line to select the current position of a player 101, and then redraw the portion of the timeline she wants to edit. As another example, the coach can edit the same line by clicking the line to select it and then use a slider 403, visible on FIG. 4, to increase or decrease its speed. As other examples, the coach can alter starting points, end points, speeds, and accelerations of lines or objects or of their sub-elements, resulting in gradual or instantaneous changes in the final animation. In all cases, the user's operations will result in a re-association of lines and objects with the timeline.

This preferred embodiment also has provisions to easily alter the playback speed of the animation 201. For example, the coach can use the interface element represented in FIG. 2 to select a desired total duration for her animation, which will result in a re-association of all graphic elements with the timeline so that playback of the entire animation occurs in the desired time interval. This preferred embodiment also has provisions to share the animation via a network 301. For example, the coach can use the interface element illustrated by FIG. 3 to upload her animation to “YouTube” or other video sharing services.

In an exemplary embodiment, the association of the timelines of the drawing events is such that recording, alteration and playback can be made while advancing at different speeds, forwards and backwards, as well as paused and stopped, through the animation's timeline or the timelines of its individual elements. For example, drawing events input while a “Pause” key 105 is pressed may be set to appear instantly in the animation. Drawing events input while a slow movement speed is selected may appear rapidly during the animation. Drawing events input while a fast movement speed 105 is selected may appear slowly during the animation. Drawing events input while a reverse movement speed 105 is selected will appear in reverse during the animation. Using methods as known from the prior art from selecting sub-portions of drawings in space (e.g. layers, selections, crop areas, groups, etc.), specific sub-portions of the animation may be edited independently in both space and time.

In an exemplary embodiment, the present invention has provisions for altering the speed at which time passes while drawing (e.g., as a function of the pressure of the pen, as a function of drawing speed, as a function of user input for example through a second scrollbar 403, (FIG. 4), etc.).

As a simple example, animation time may only advance when a pen is touching the drawing area and stand still otherwise. As a slightly more complex example, animation time may advance as a logarithmic function of the users drawing speed. As yet another example, animation time may advance as a spatial function of the user input, such that time advances slowly when drawing close to the center but more quickly when drawing at the borders of the image.

In an exemplary embodiment, illustrated by FIGS. 5 and 6, movement in time is linked to a predefined processing rule for information display. For example, each point in time may be linked with a predefined zoom level, such that playback of a drawn circle will result in an animation of flying into a spiral and playback of a line drawn radially from the zoom center at the right speed will appear as a point in the animation. Other examples of predefined processing rules include rotation, panning/shifting/drift operations, mirroring, or other more complex operations and transformations of the canvas described by a function or algorithm.

For example, one such processing rule may make portions of lines disappear 5 seconds after their starting point in the animation, 5 seconds before their end point, or after 5 seconds in the animation's timeline.

In another exemplary embodiment intended for entertainment, the present invention is used in the fashion of computer-implemented online or offline games. In this embodiment the timeline of one animation may be linked to that of another such that both animations are shown in parallel or in sequence both, in time or in space. For example, to create a challenging and entertaining way of drawing an animation, a user may be given the end point of another user's animation as a starting point for her animation. The user would then create her own animation and mark it as completed, upon which another, different user would be given the new end point as a starting point. This allows multiple users to collaboratively create a single animated video sequence with smooth transitions between their individual contributions. Other additional constraints, such as using a color palette with all except one of the previous' animation's colors, may be imposed.

As another, related example, a user may be given another user's animation as a part of their animation (e.g., as the left half of their animation or as a square at the center). The user would then create her own animation in such a way that it connects to the previous animation in space and in time (e.g., such that lines drawn in the previous animation continue in the user's animation).

As another example of creating a challenging and entertaining way of drawing an animation, the timeline may be linked to an operation in space. For example, the timeline may be linked to a zoom operation, with each point in time linked to a specific zoom level. In this example, a pen placed at the exact center of the drawing area will start the timeline and result in an animation of an expanding filled circle, and a pen placed next to the center of the drawing area will result in a radial line.

As another example, the timeline may be linked to an operation in time. For example, the timeline may be entirely controlled by a predefined processing rule. In this example, a user may be presented with a continuously running 10 second long animation that will automatically loop back to its beginning. In this example, a pen placed at the exact center of the drawing area for 5 seconds will result in a dot that appears and disappears in a 5 second interval.

Adaptation and combination of these examples gives rise to a large number of possibilities, where drawing events are associated with timelines by various functions.

With reference to FIG. 4, in another exemplary embodiment intended for the creation of art, the present invention allows an artist to create an animated drawing by enhancing the typical features of modern drawing applications (color selector, color picker, undo, redo, layers, brushes, erasers 109 (visible on FIG. 1), and the like 401) with a way to manipulate the animation's timeline 402.

In this embodiment, the enhancement is introduced as a slider 402, 102, with buttons 105 (visible in FIG. 1). This embodiment also has an additional option to quickly returning to a set point in time by either setting and activating a set-point using a double-click on the slider 402, 102, or by use of a special button at the end point of the slider 402, or by use of a shortcut key or any suitable interface element. Optionally, this set point in time may be defined as the starting point of the last line drawn and, optionally, programmed to return to this point upon reaching the end point of the last line drawn. This last option would, for example, allow a user to easily create an animation of growing grass by drawing many individual lines representing individual blades of grass, which would then automatically appear to grow in parallel in the animation.

In an exemplary embodiment, the invention includes a method to project the entire animation onto one image (i.e., collapsing the entire timeline to a single point in time), such that the drawings created at predefined zoom levels will result in a single drawing with multiple levels of detail.

In an exemplary embodiment, the user interface is a touch screen, drawing tablet, keyboard, mouse, joystick, or similar device.

In an exemplary embodiment, the input information is provided by the user via the movement of a curser, an object such as a ball, the motion of a screen character, or the definition of a rule or function. For example, in a first step a user could be asked to draw a landscape. In a second step, a ball rolling down a predefined landscape governed by the functions describing the laws of Physics could provide additional drawing events for the animation. In another, related example, input information is a function of the timing of another animation.

In an exemplary embodiment, the input information is provided by a combination of user input and a predetermined rule. For example, a user may input a drawing event which will be associated to a timeline. A predetermined rule will move segments towards the bottom of the image depending on their age, such that lines continuously drift towards the bottom throughout the animation, such that a series of dots drawn at the top of the canvas throughout the animation will result in an animation of falling dots similar to rain.

In an exemplary embodiment, the present invention allows the input information to be a letter of the alphabet or other symbol.

In an exemplary embodiment, the user uses a slider, scrollbar, mouse wheel, button or similar method to go back and forward in time.

In an exemplary embodiment, the time recording can be coupled to another timeline, such as that from another animation for an even more advanced control of the timeline.

In an exemplary embodiment, the method includes provisions to use methods for the manipulation of drawings and animations as known from the prior art (e.g., path smoothing (matching spline angles) and trajectory smoothing (matching drawing speed and acceleration) of drawn, edited and joined lines, tweening, adding and removing items from the animation, editing items from the animation individually or simultaneously, copy-paste, distortion, etc.).

In an exemplary embodiment, the present invention has provisions for drawing in more than two dimensions. For example, using features as explained above, a user may draw a cube in three dimensions by first pausing the animation and inputting a square, then setting a time marker on the animation slider, then unpausing the animation, then placing the pen on the first corner for 1 second, then using a shortcut key to returning to the time defined by the time marker, then placing the pen on the second corner for 1 second, then again using the shortcut key to return to the time defined by the time marker, then repeating the process for corners 3 and 4, then pausing the animation and then drawing a final square.

1. A computer implemented method, comprising the steps of:
receiving an indication of a first drawing event,
associating this first drawing event with a first timeline,
receiving an indication of a second drawing event,
associating this second drawing event with a second timeline,
associating the first timeline with the second timeline,
displaying on a canvas the first and second drawing events according to the association of their timelines.

2. The method of claim 1, further comprising the steps of:
Receiving one or more indications of one or more additional drawing events,
Associating these additional drawing events with additional timelines,
Associating these additional timelines with existing timelines.
Displaying the previous and these additional drawing events according to the associations of timelines.

3. The method of claim 2, wherein indications of drawing events are received from more than one user.

4. The method of claim 1, further comprising the steps of: recording the drawing events, their associations with timelines, the associations between timelines, or the display of drawing events.

5. The method of claim 1, further comprising the step of sharing the recording via a network.

6. The method of claim 1, wherein an indication of a drawing event is received through user input, a software agent, a hardware agent, or another entity.

7. The method of claim 1, wherein a drawing event includes a line, line segment, point, stencil, brush stroke, mark, objects, letters, symbols, or the like.

8. The method of claim 1, wherein a timeline is discrete and defined by a starting point, the size of a discrete time step, and an end point; or by the relative timespans between received drawing events.

9. The method of claim 1, wherein the association between a drawing event and a timeline is accomplished using a discrete mapping of each drawing event to a particular point on the timeline.

10. The method of claim 9, wherein this discrete mapping is a function of properties of the drawing event, properties of the timeline, or user input.

11. The method of claim 1, wherein a drawing event is received during replay of at least one previous drawing event.

12. The method of claim 1, providing a step of associating a timeline with a processing rule.

13. The method of claim 12, wherein the processing rule associated to a timeline is a function of properties of the drawing event, properties of the timeline, or user input.

14. The method of claim 12, wherein the processing rule associated to a timeline performs a transformation of the drawing event.

15. The method of claim 12, wherein the processing rule associated to a timeline performs a transformation of the canvas.

16. The method of claim 12, wherein the processing rule associated to a timeline alters where drawing events are received on the timeline.

17. The method of claim 1, providing a step of associating a drawing event with a processing rule.

18. The method of claim 17, wherein the processing rule associated to a drawing event is a function of properties of the drawing event, properties of the timeline, or user input.

19. The method of claim 17, wherein the processing rule associated to a drawing event performs a transformation of the drawing event or a transformation of the canvas.

20. The method of claim 17, wherein the processing rule associated to a drawing event alters where drawing events are received on the timeline.

21. The method of claim 1, providing a step of associating user input with a processing rule.

22. The method of claim 21, wherein the processing rule associated to user input is a function of properties of the drawing event, properties of the timeline, or user input.

23. The method of claim 21, wherein the processing rule associated to user input performs a transformation of the drawing event or of the canvas.

24. The method of claim 21, wherein the processing rule associated to user input alters where drawing events are received on the timeline.

25. The method of claim 1, comprising steps of switching between modes of advancing through the timeline, or of jumping to defined positions in the timeline dependent of properties of the drawing event, properties of the timeline, or user input.

26. The method of claim 25, comprising steps of switching between modes of advancing through the timeline, or of jumping to defined positions in the timeline, dependent of the starting or end points in the timeline, or of drawing events.

27. The method of claim 1, comprising steps of receiving, associating, altering, displaying, or recording the relation of drawing events with their associated timelines.

28. The method of the preceding claim, wherein the steps of receiving, associating, altering, displaying, or recording the relation of drawing events happen while advancing through the timeline at different speeds, forwards or backwards, or while pausing the progression in the timeline.

29. The method of claim 1, using tools for the receiving, associating, altering, displaying, or recording of drawings or animations. In particular, allowing for various ways of controlling the timeline and of easy receiving, associating, altering, displaying, or recording of sub-sections of drawing events in space or time as well as the use of timelines of drawing events to link drawing events created by different users in time or in space.

30. The method of claim 1, comprising a step of altering the speed at which the time passes as a function of user input.

31. The method of claim 1, comprising a step of returning to a set point in time upon action of the user on a interface element.
